(19) United States
(12) Patent Application Publication
(10) Pub. No.: US 2018/0172881 A1
(43) Pub. Date: Jun. 21, 2018

(54) ANTI-REFLECTIVE TANDEM STRUCTURE AND FABRICATION METHOD THEREOF, SUBSTRATE AND DISPLAY APPARATUS

(71) Applicant: BOE TECHNOLOGY GROUP CO., LTD, Beijing (CN)

(72) Inventors: FENG ZHANG, Beijing (CN); ZHANFENG CAO, Beijing (CN); QI YAO, Beijing (CN)

(21) Appl. No.: 15/038,118

(22) PCT Filed: Dec. 10, 2015
(86) PCT No.: PCT/CN2015/096926

§ 371 Date: May 20, 2016

(30) Foreign Application Priority Data
Apr. 1, 2015 (CN) 2015-10152771.7

(51) Int. Cl. G02B 1/113; G02B 5/20; G02B 5/00; G02F 1/1335; G02F 1/1362

(52) U.S. Cl. CPC G02B 1/113; G02B 5/205; G02F 1/1362; G02F 1/133512; G02B 5/003

(57) ABSTRACT

An anti-reflective tandem structure is provided. The anti-reflective tandem structure comprises a plurality of light-absorbing layers, wherein at least two of the plurality of light-absorbing layers have different concentrations of a non-metal element.

### CROSS-REFERENCES TO RELATED APPLICATIONS

This PCT application claims the priority of Chinese Patent Application No. 201510152771.7, filed on Apr. 1, 2015, the entire contents of which are incorporated by reference herein.

### FIELD OF THE INVENTION

The present invention generally relates to the field of display technologies and, more particularly, to an anti-reflective tandem structure and a fabrication method thereof, a substrate, and a display apparatus.

### BACKGROUND

Thin Film Transistor Liquid Crystal Display (TFT-LCD) is one of the important types of display panels. It has been widely used in TVs, lap-top computers, monitors and cell-phones, etc.

In a TFT-LCD panel, because the electrical fields in the region of the TFTs, data lines and the gate lines, etc. may be out of control. Thus, a black matrix is needed to block light emitted from the region of the TFTs, the data lines and the gate lines, etc. By disposing the black matrix, the display performance of the TFT display panel may be enhanced.

In the existing methods, the black matrix is often made of metal material. Because the metal material may have a certain reflectivity, the black matrix made of metal material may reflect light. Thus, the display contrast of the display panel may be significantly reduced; and the image quality may be adversely affected. Further, the reflectivity of the display panel having the black matrix made of metal material may be proportional to the area of the black matrix. Thus, the larger the area of the black matrix is, the larger the reflectivity of the display panel is, and the display contrast may be significantly reduced. The disclosed methods and apparatus are directed to at least partially alleviate one or more problems set forth above and other problems.

### BRIEF SUMMARY OF THE DISCLOSURE

One aspect of the present disclosure includes providing an anti-reflective tandem structure. The anti-reflective tandem structure comprises a plurality of light-absorbing layers; and at least two of the plurality of light-absorbing layers have different concentrations of a non-metal element.

Optionally, concentrations of the non-metal element in different layers of the plurality light-absorbing layers increase along a thickness direction.

Optionally, concentrations of the non-metal element in different layers of the plurality light-absorbing layers increase firstly, and then decrease along a thickness direction.

Optionally, concentrations of the non-metal element in different layers of the plurality of the light-absorbing layers are symmetric with a light-absorbing layer with the highest non-metal concentration.

Optionally, the concentration of the non-metal element in each of the plurality of light-absorbing layers is in a range of approximately 0˜15%.

Optionally, a thickness of the light-absorbing layers is in a range of approximately 10 nm˜50 nm.

Optionally, the thickness of the light-absorbing layers is approximately 20 nm.

Optionally, the anti-reflective tandem structure further includes a transparent layer on the top and/or bottom surface of the anti-reflective tandem structure.

Optionally, the light-absorbing layers are made of one of metal oxide, metal nitride and metal oxynitride.

Optionally, the metal oxide includes one or more of AlOₓ, CrOₓ, CuOₓ, MoOₓ, TiOₓ, AlNdOₓ, CuMoOₓ, MoTaOₓ, and MoTiOₓ, wherein “x” is an integer; the metal nitride includes one or more of AlN_{y}, CrN_{y}, CuN_{y}, MoN_{y}, TiN_{y}, AlNdN_{y}, CuMoN_{y}, MoTaN_{y}, and MoTiN_{y}, wherein “y” is an integer; and the metal oxynitride includes one or more of AlNₐO_{b}, CrNₐO_{b}, CuNₐO_{b}, MoNₐO_{b}, TiNₐO_{b}, AlNdNₐO_{b}, CuMoNₐO_{b}, MoTaNₐO_{b}, MoTiNₐO_{b}, wherein “a” and “b” are integers.

Another aspect of the present disclosure includes providing a substrate. The substrate comprises a base substrate; and a disclosed anti-reflective tandem structure on the base substrate.

Optionally, the substrate is a display substrate; and the anti-reflective tandem structure is a black matrix on the display substrate.

Optionally, the display substrate is a color filter on array (COA) substrate; and the anti-reflective tandem structure is a black matrix disposed around pixel electrodes.

Optionally, the substrate is a touch substrate; and the anti-reflective tandem structure is a bridging structure for connecting sensing electrodes on the substrate.

Another aspect of the present disclosure includes providing a display apparatus. The display apparatus comprises any one of the disclosed substrates.

Another aspect of the present disclosure includes providing a method for fabricating an anti-reflective tandem structure. The method includes providing a base substrate; and forming a plurality of light-absorbing layers on the base substrate, wherein at least two of the plurality of light-absorbing layers have different concentrations of an non-metal element.

Optionally, concentrations of the non-metal element in different layers of the plurality light-absorbing layers increase from one surface of the anti-reflective tandem structure to the other surface of the anti-reflective tandem structure.

Optionally, concentrations of the non-metal element in different layers of the plurality light-absorbing layers increase firstly, and then decrease, from one surface of the anti-reflective tandem structure to the other surface of the anti-reflective tandem structure.

Optionally, each of the light-absorbing layers may be formed by a sputtering process; a target of the sputtering process is one of metal and metal alloy; and an environmental gas of the sputtering process is one of a mixture of Ar and O₂, a mixture of Ar and N₂, and a mixture of Ar, N₂ and O₂.

Optionally, a substrate temperature during the sputtering process is in a range of approximately 25° C.˜150° C.; a power of the sputtering process is in a range of approximately 5 kW˜15 kW; and a pressure of the sputtering process is in a range of approximately 0.1 Pa˜0.5 Pa; a concentration of O₂ in the Ar and O₂ mixture is in a range of approximately 0˜20%; a concentration of N₂ in the Ar and N₂ mixture is in a range of approximately 0˜20%; and a total concentration of O₂ and N₂ in the Ar, N₂ and O₂ mixture is in a range of approximately 0˜20%.

Optionally, the metal includes one of Al, Cr, Cu, Mo and Ti; and the metal alloy includes one of AlNd, CuMo, MoTa and MoTi.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary anti-reflective tandem structure according to the disclosed embodiments;

FIG. 2 illustrates another exemplary anti-reflective tandem structure according to the disclosed embodiments;

FIG. 3 illustrates another exemplary anti-reflective tandem structure according to the disclosed embodiments;

FIG. 4 illustrates another exemplary anti-reflective tandem structure according to the disclosed embodiments;

FIG. 5 illustrates another exemplary anti-reflective tandem structure according to the disclosed embodiments;

FIG. 6 illustrates an exemplary substrate according to the disclosed embodiments;

FIG. 7 illustrates an exemplary display substrate according to the disclosed embodiments;

FIG. 8 illustrates a cross-sectional view of the display substrate illustrated in FIG. 7 along the A-A′ direction;

FIG. 9 illustrates a cross-sectional view of the display substrate illustrated in FIG. 7 along the B-B′ direction;

FIG. 10 illustrates another exemplary display substrate according to the disclosed embodiments;

FIG. 11 illustrates another exemplary display substrate according to the disclosed embodiments;

FIG. 12 illustrates an exemplary touch substrate according to the disclosed embodiments;

FIG. 13 illustrates an exemplary fabrication process of an anti-reflective tandem structure according to the disclosed embodiments; and

FIG. 14 illustrates a block diagram of an exemplary display apparatus according to the disclosed embodiments.

### DETAILED DESCRIPTION

Reference will now be made in details to exemplary embodiments of the invention, which are illustrated in the accompanying drawings.

According to the disclosed embodiments, an anti-reflective tandem structure is provided. FIG. 1 illustrates an exemplary anti-reflective structure.

As shown in FIG. 1, the anti-reflective tandem structure 100 includes a plurality of light-absorbing layers 100a. The anti-reflective tandem structure 100 may be made of a mixture of metal material and non-metal material. The non-metal material may be in a metal oxide form. The mixture of the metal material may be a metal oxide compound, or a solid state solution of the metal material and the metal oxide. The anti-reflective tandem structure 100 may be used as a black matrix of a substrate. Further, at least two of the plurality of light-absorbing layers 100a may have different concentrations of non-metal material.

The anti-reflective tandem structure 100 may have two surfaces which may be referred as a top surface and a bottom surface. Light may irradiate on the top surface and/or the bottom surface of the anti-reflective tandem structure 100. Because the anti-reflective tandem structure 100 may include the plurality of light-absorbing layers 100a, and the light-absorbing layers 100a may absorb the external environmental light, the reflection of the external environmental light caused by the anti-reflective tandem structure 100 may be reduced. That is, the reflectivity of a display panel having such anti-reflective tandem structure may be reduced.

For example, comparing with a display panel having an existing black matrix, the reflectively of a display panel having the anti-reflective tandem structure as a black matrix may be reduced from approximately 50% to less than approximately 10%. When the anti-reflective tandem structure 100 is used in a display apparatus for blocking the substrate, it may prevent the reflective light from increasing a minimum brightness of pure black. The display contrast is equal to a maximum brightness of pure white divided by the minimum brightness of pure black. Thus, decreasing the minimum brightness of pure black may increase the display contrast; and the image quality of the display panel may be enhanced.

In one embodiment, two or more of the light-absorbing layers 100a may have different concentrations of non-metal material. Thus, the colors of the two or more light-absorbing layers 100a may be different; and the light-absorbing ability of the two or more light-absorbing layers 100a may be different. In order to cause the anti-reflective tandem structure 100 to have an optimized light-absorbing ability, the plurality of the light-absorbing layers 100a may be arranged with their light-absorbing ability gradually changing. That is, the concentrations of the non-metal elements of in different layers of the plurality of light-absorbing layers 100a may gradually change.

In one embodiment, as shown in FIG. 1, the concentration of the non-metal element in each of the plurality of light-absorbing layers 100a is a constant. The concentrations of the non-metal element in different light-absorbing layers 100a gradually increase or decrease from one surface of the anti-reflective tandem structure 100 to the other surface. That is, the non-metal element in different light-absorbing layers 100a of the anti-reflective tandem structure 100 has a concentration gradient in the direction along the depth of the light-absorbing layers 100a or the anti-reflective tandem structure 100.

In certain other embodiments, the non-metal element in each of the light-absorbing layers 100a may have a sub-concentration gradient. The directions of the concentration gradients of the plurality of light-absorbing layers 100a may be identical, or may be different.

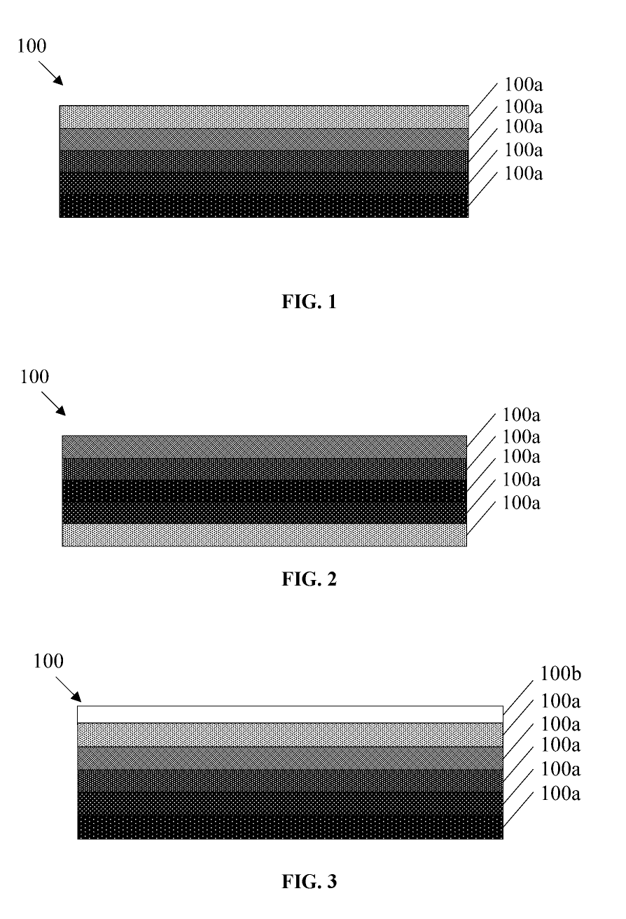

In still certain other embodiments, as shown in FIG. 2, the concentrations of the non-metal element in different light-absorbing layers 100a gradually increase firstly, and then gradually decrease, from one surface of the anti-reflective tandem structure 100 to the other surface. That is, different light-absorbing layers 100a of the anti-reflective tandem structure 100 may have two concentration gradients from one surface to the other surface; and the directions of the concentration gradients may be opposite.

In certain other embodiments, each of the plurality of light-absorbing layers 100a may have two concentration gradients, and the directions of the two concentration gradients may be opposite. In still certain other embodiments, the concentrations of the non-metal element in different light-absorbing layers 100a may be random values.

The concentration difference between two adjacent light-absorbing layers 100a may be a pre-determined constant. For example, the concentration difference between two adjacent light-absorbing layers 100a may be approximately 1%. In certain other embodiments, the concentration differences between adjacent light-emitting layers 100a may be different.

The anti-reflective tandem structure 100 illustrated in FIG. 1 may be used for absorbing light irradiating from one side, such as the inner light of a display apparatus, or the external environmental light of a display apparatus. Such an anti-reflective tandem structure 100 may also have a certain absorption from the other side of the display apparatus.

The anti-reflective tandem structure 100 illustrated in FIG. 2 may be used for absorbing light irradiating from both top surface and bottom surface. For example, such an anti-reflective structure 100 may absorb the inner light and the external environmental light of a display apparatus simultaneously.

When the concentrations of the non-metal element in different light-absorbing layers 100a increase firstly and then decreases, from one surface to the other surface of the anti-reflective structure 100, the two concentration gradients may be symmetrical with the light-absorbing layer 100a with the highest concentration of non-metal element. In certain other embodiments, the two concentration gradients may be asymmetrical.

In practical applications, the concentrations of the non-metal element in different light-absorbing layers 100a may be designed according to specific requirements. For example, in a practical application, the concentration of the non-metal element in each of the light-absorbing layers 100a may be designed according to the intensities of the inner light and the external environmental light of the display panel so as to better absorb the inner light and the external environmental light.

In one embodiment, the concentration of the non-metal element in each of the light-absorbing layers 100a may be in a range of approximately 0˜15%. The light-absorbing layers 100a having such a range of non-metal element may have a desired light-absorbing performance to the external environmental light.

The thicknesses of the plurality of light-absorbing layers 100a may be identical or different. The thickness of one light-absorbing layer 100a may be in a range of approximately 10 nm˜50 nm. In one embodiment, the thickness of the light-absorbing layer 100a is approximately 20 nm.

The light-absorbing layers 100a may be made of any appropriate material, such as one or more of metal oxide, metal nitride, and metal oxynitride, etc. The metal oxide may include one or more of AlOₓ, CrOₓ, CuOₓ, MoOₓ, TiOₓ, AlNdOₓ, CuMoOₓ, MoTaOₓ, and MoTiOₓ, etc. Wherein “x” is an integer. The metal nitride may include one or more of AlN_{y}, CrN_{y}, CuN_{y}, MoN_{y}, TiN_{y}, AlNdN_{y}, CuMoN_{y}, MoTaN_{y}, and MoTiN_{y}, etc. Wherein “y” is an integer. The metal oxynitride may include one or more of AlNₐO_{b}, CrNₐO_{b}, CuNₐO_{b}, MoNₐO_{b}, TiNₐO_{b}, AlNdNₐO_{b}, CuMoNₐO_{b}, MoTaNₐO_{b}, and MoTiNₐO_{b}, etc. Wherein “a” and “b” are integers, or decimals.

Further, as shown in FIG. 3, in one embodiment, the anti-reflective tandem structure 100 may include a transparent layer 100b disposed on one surface of the anti-reflective tandem structures 100 illustrated in FIG. 1 or FIG. 2. The surface may be the top surface or the bottom surface of the anti-reflective tandem structure 100. The transparent layer 100b may be made of metal. Thus, the transparent layer 100b may be referred as a transparent metal layer 100b.

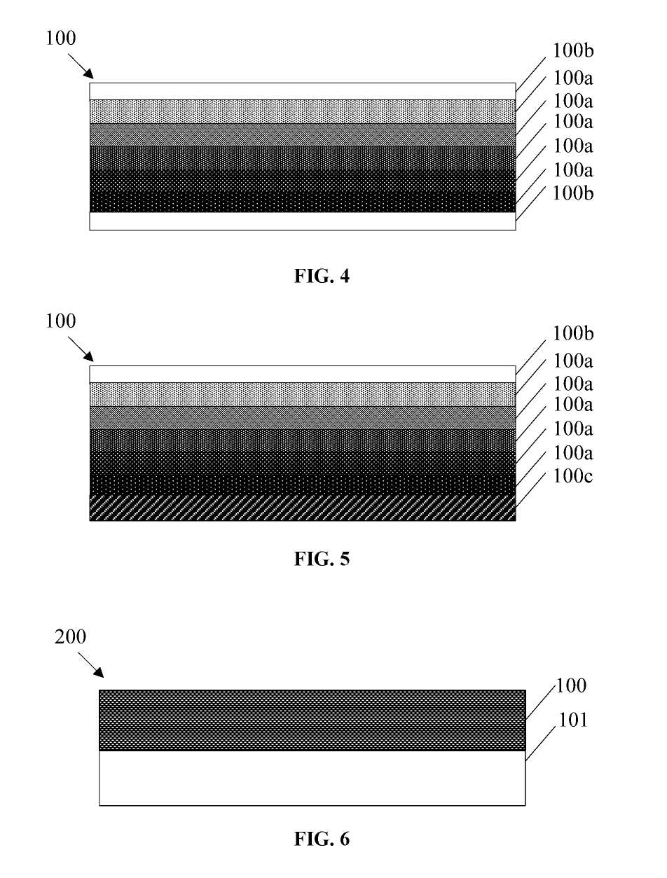

In certain other embodiments, as shown in FIG. 4, the anti-reflective tandem structure may include two transparent metal layers 100b formed on the two surfaces of the anti-reflective structures 100 illustrated in FIG. 1 or FIG. 2, respectively.

Referring to FIG. 3 and FIG. 4, the transparent metal layers 100b may be disposed on the top surface and/or the bottom surface of the structure comprising the plurality of light-absorbing layers 100a, the transparent metal layers 100b may not adversely affect the absorbing effect of the anti-reflective tandem structure 100. Further, the transparent metal layers 100b may be able to increase the conductivity of the anti-reflective tandem structure 100. The increased conductivity of the anti-reflective tandem structure 100 may enhance the properties of the device or apparatus having the anti-reflective tandem structure 100.

For example, when the anti-reflective tandem structure 100 is used as a black matrix in an array substrate, a common electrode is often formed on the black matrix. That is, the black matrix may be electrically connected with the common electrode. A portion of the black matrix and the common electrode may be electrically connected as two equivalent resistors connected in parallel. Thus, when the conductivity of the black matrix is increased, the resistance of the portion of the black matrix electrically connected with the common electrode may be smaller than the resistance of the common electrode. Therefore, the voltage difference caused by the resistance of the common electrode may be reduced; and the display resolution may be enhanced.

Further, when the anti-reflective tandem structure 100 having the transparent metal layers 100b is used as a black matrix, because the black matrix may have a desired electrical properties, the black matrix may also be used as interconnect lines, such as data lines, and gate lines, etc. Thus, the production cost may be reduced.

The transparent metal layers 100b may be made of any appropriate metal or metal alloy, such as Al, Cr, Cu, Mo, Ti, AlNd, CuMo, MoTa, or MoTi, etc. The thickness of the transparent metal layers 100b may be in a range of approximately of 10 nm˜50 nm. Such a thickness may cause the transparent metal layers 100b to have a desired transparency. In one embodiment, the thickness of the transparent metal layers 100b is approximately 30 nm.

Further, as shown in FIG. 5, the anti-reflective tandem structure 100 may also include a buffer layer 100c formed on one surface of the anti-reflective structure illustrated FIG. 3. The surface may be the top surface or the bottom surface.

The buffer layer 100c may be used to increase the bonding force of the anti-reflective tandem structure 100. For example, when the anti-reflective structure 100 is used as a black matrix, the buffer layer 100c may increase the bonding force between the black matrix and the substrate.

The buffer layer 100c may be made of any appropriate material, such as Al, Cr, Cu, Mo, Ti, AlNd, CuMo, MoTa, or MoTi, etc. In certain other embodiments, the buffer layer 100c may have a multiple-layer structure.

FIG. 6 illustrates an exemplary substrate 200 according to the disclosed embodiments. As shown in FIG. 6, the substrate 200 may include a base substrate 101 and a disclosed anti-reflective tandem structure 100 formed over the base substrate 101. In one embodiment, the anti-reflective tandem structure 100 may be formed on the base substrate 101 directly. In certain other embodiments, one or more layers and/or devices and/or structures may be formed on the base substrate 101; and the anti-reflective tandem structure 100 may be formed on the one or more layers and/or devices and/or structures.

In one embodiment, the substrate 200 may be a display substrate, or a touch substrate. In certain other embodiments, the substrate 200 may be other type of substrates. When the substrate 200 is a display substrate, the anti-reflective tandem structure 100 may be a black matrix on the display substrate. When the substrate 100 is a touch substrate, the anti-reflective tandem structure 100 may be a bridging structure for connecting sensing electrodes.

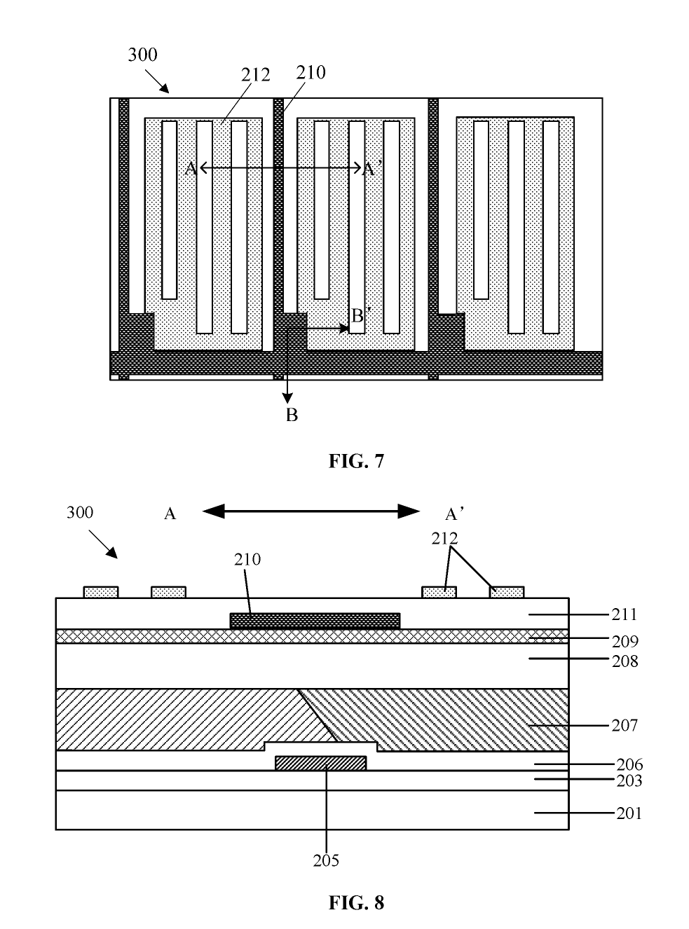

FIG. 7 illustrates an exemplary display substrate 300 according to the disclosed embodiments. The display substrate 300 may be a Color Filter On Array (COA) substrate. The disclosed anti-reflective tandem structure may be a black matrix 210 of the COA substrate. As shown FIG. 7, the black matrix 210 may be disposed around pixel electrodes 212.

FIG. 8 illustrates a cross-sectional view of the display substrate 300 illustrated in FIG. 7 along the AA′ direction. As shown in FIG. 8, the COA substrate may include a base substrate 201, and a gate insulating layer 203 formed on the base substrate 201. The COA substrate may also include a source/drain structure 205 formed on the gate insulating layer 203, and a first passivation layer 206 formed on the source/drain structure 205 and the gate insulating layer 203. Further, the COA substrate may include a color filter 207 formed on the first passivation layer 206, and an organic planarizing layer 208 formed on the color filter 207. Further, the COA substrate may also include a common electrode 209 formed on the organic planarizing layer 208, and the black matrix 210 formed on the common electrode 209. Further, the COA substrate may also include a second passivation layer 211 formed on the black matrix 210 and the common electrode 209, and the pixel electrodes 212 formed on the second passivation layer 211.

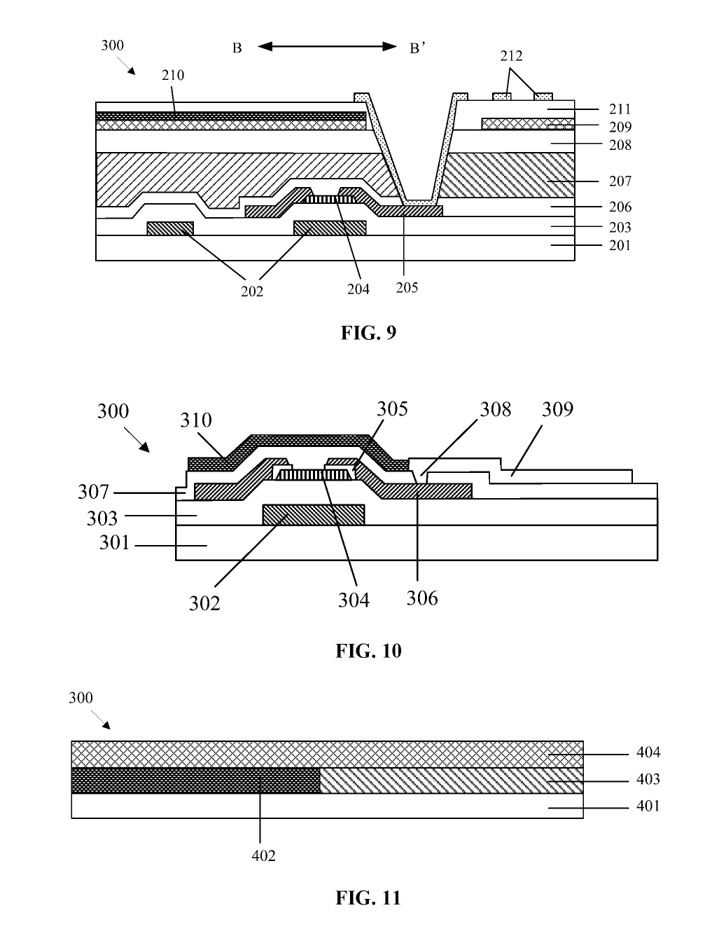

FIG. 9 illustrates a cross-sectional view of the display substrate 300 illustrated in FIG. 7 along the BB′ direction. As shown in FIG. 9, the display substrate 300 may also include gate electrodes 202 formed on the base substrate 201, and an active layer 204 formed on the gate insulating layer 203. The gate electrodes 202, the gate insulating layer 203, the active layer 204 and the source/drain structure 205 may form a thin-film transistor (TFT) structure. The TFT structure may be formed on the base substrate 201; and the first passivation layer 206 may cover the TFT structure.

In such a COA substrate, the black matrix 210 may be formed on the common electrode 209; and the black matrix may cover the source/drain structure 205. In certain other embodiments, the black matrix 210 may be disposed on any appropriate position of the COA substrate.

FIG. 10 illustrates another exemplary display substrate according to the disclosed embodiments. The display substrate may be an array substrate 300. As shown in FIG. 10, the array substrate 300 may include a base substrate 301, and a gate electrode 302 formed on the base substrate 301. The array substrate may also include a gate insulation layer 303 covering the gate electrode 302, and a source layer 304, an n⁺-type layer 305 and a source/drain structure 306 formed on the gate insulation layer 303. Further, the array substrate 300 may also include a protective layer 307 covering the source/drain structure 306, and a contact hole 308 corresponding to a drain region formed on the protective layer 307. Further, the array substrate 300 may also include a pixel electrode 309 connecting with the drain region through the contact hole 308 formed on the protective layer 307, and a black matrix 310 covering the source/drain structure 306 formed on the protective layer 307.

The disclosed anti-reflective tandem structure may be used as the black matrix 310 of such an array substrate. In certain other embodiments, the black matrix 310 may be disposed on other appropriate position of the array substrate 300.

FIG. 11 illustrates another exemplary display substrate according to the disclosed embodiments. The display substrate may be a color film substrate 300. As shown in FIG. 11, the color film substrate 300 may include a base substrate 401, a black matrix 402 and a color filter 403 formed on the base substrate 401, and a common electrode 404 formed on the black matrix 402 and the color filter 403.

The disclosed anti-reflective tandem structure may be used as the black matrix 402 of such a color film substrate. In certain other embodiments, the black matrix 402 may be disposed on other appropriate position of the color film substrate.

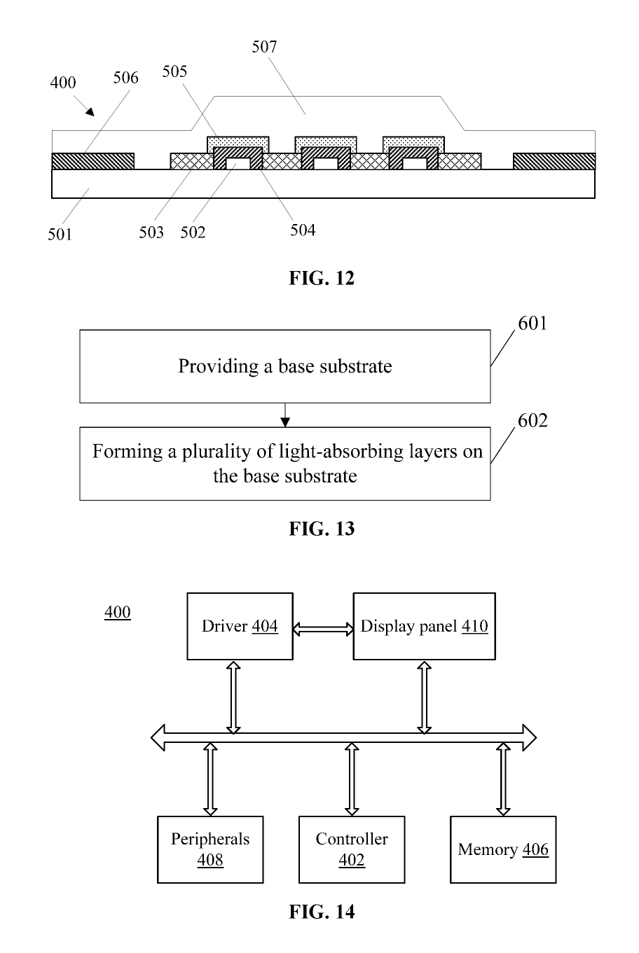

FIG. 12 illustrates an exemplary touch substrate 400 according to the disclosed embodiments. As shown in FIG. 12, the touch substrate 400 may include a base substrate 501, and driving electrodes 502 and sensing electrodes 503 formed on the base substrate 501. The driving electrodes 502 and the sensing electrodes 503 may be crossly distributed on a same layer. The touch substrate 400 may also include an insulation layer 504 between adjacent sensing electrodes 503 and bridging structures 505 for connecting adjacent sensing electrodes 503 formed on the insulation layer 504. Further, the touch substrate 404 may also include leads 506 formed on the edge region, and a protective layer 507 covering the entire base substrate 501. Through holes (not shown) may be disposed in the protective layer 507 to expose the leads 506 to connect the leads 506 with chips or ICs, etc.

The disclosed anti-reflective tandem structure may be used as the bridging structure 505 of the touch substrate 400. In certain other embodiments, the bridging structure 505 may be disposed on other appropriate positions of the touch substrate.

The substrates illustrated in FIGS. 6˜12 only illustrate some exemplary structures, certain other structures and/or layers may be included; and some structures in the substrates may be omitted. The layer sequence in the substrate may vary; and the position of the anti-reflective tandem structure may be different, as long as the substrate is able to function properly.

FIG. 13 illustrates an exemplary fabrication process of anti-reflective tandem structure. As shown in FIG. 13, the method may include providing a base substrate (S601).

The base substrate may be made of any appropriate material, such as semiconductor material, glass, or organic material, etc. The base substrate provides a base for subsequent devices and processes.

Further, as shown in FIG. 13, after providing the base substrate, a plurality of light-absorbing layers may be formed on the base substrate (S602). Thus, an anti-reflective tandem structure may be formed on the base substrate. The anti-reflective tandem structure may refer to FIGS. 1˜5.

The light-absorbing layers may formed by any appropriate process, such as a chemical vapor deposition process, a physical vapor deposing, or an atomic layer deposition process, etc. In one embodiment, the light-absorbing layers are formed by a sputtering process.

In one embodiment, metal or metal alloy may be used as the target of the sputtering process to form light-absorbing layers. The sputtering process may be performed in an Ar/O₂ environmental. The formed light-absorbing layers may include metal oxide.

In certain other embodiment, metal or metal alloy may be used as the target of the sputtering process to form light-absorbing layers. The sputtering process may be performed in an Ar/N₂ environmental. The formed light-absorbing layers may include the metal nitride.

In certain other embodiment, metal or metal alloy may be used as the target of the sputtering process to form light-absorbing layers. The sputtering process may be performed in an Ar/O₂/N₂ environmental. The formed light-absorbing layers may include the metal oxynitride.

The temperature of the base substrate during the sputtering process may be in a range of approximately 25° C.˜150° C. The sputtering power may be in a range of approximately 5 kW˜15 kW. The pressure of the sputtering process may be in a range of approximately 0.1 Pa˜0.5 Pa.

When an Ar and O₂ mixture is used to form the light-absorbing layers, the concentration of O₂ in the mixture may be in a range of approximately 0˜20%. When an Ar and N₂ mixture is used to form the light-absorbing layers, the concentration of N₂ in the mixture may be in a range of approximately 0˜20%. When an Ar, O₂ and N₂ mixture is used to form the light absorbing layers, the total concentration of N₂ and O₂ may be in a range of approximately 0˜20%. By adjusting the concentration of O₂, N₂, or N₂ and O₂ in the mixture, the concentration of the non-metal element in the formed light-absorbing layers may be controlled to match the designed requirements.

The metal may include Al, Cr, Cu, Mo or Ti, etc. The metal alloy may include AlNd, CuMo, MoTa or MoTi, etc.

In certain other embodiments, the plurality of light-absorbing layers may be patterned to form the anti-reflective tandem structure. Various processes may be used to pattern the plurality of light-absorbing layers, such as a dry etching process, a wet etching process, or an ion beam etching process.

Further, in certain other embodiments, before and/or after forming the plurality of light-absorbing layers, the flow rate of O₂ in the Ar and O₂ mixture may be controlled as 0. Thus, a transparent metal layer may be formed.

Further, in certain other embodiments, before and/or after forming the plurality of the light-absorbing layers, the flow rate of N₂ in the Ar and N₂ mixture may be controlled as 0. Thus, a transparent metal layer may be formed.

Further, in certain other embodiments, before and/or after forming the plurality of the light-absorbing layers, the total flow rate of O₂ and N₂ in the Ar, O₂ and N₂ mixture may be controlled as 0. Thus, a transparent metal layer may be formed.

In one embodiment, the thickness of the transparent metal layer may be in a range of approximately 10 nm˜50 nm. Such a thickness range may not affect the light-absorbing to the environmental light, and may increase electrical conductivity of the anti-reflective tandem structure. In one embodiment, the thickness of the transparent metal layer is approximately 30 nm.

Further, in certain other embodiments, before and/or after forming the plurality of the light absorbing layers, a buffer layer may be formed. The disposing of the buffer layer may increase the adhesion force of the anti-reflective tandem structure. For example, when the anti-reflective tandem structure is used as a black matrix, disposing the buffer layer may increase the adhesion force between the black matrix and the base substrate.

The buffer layer may be made of metal, such as Al, Cr, Cu, Mo, Ti, AlNd, CuMo, MoTa or MoTi, etc. The buffer layer may also be a commonly used buffer structure.

Further, the present disclosure also includes providing a display apparatus. The display apparatus may include any one of the disclosed substrates. FIG. 14 illustrates an exemplary display apparatus 400 incorporating the disclosed substrate and other aspects of the present disclosure.

The display apparatus 400 may be any appropriate device or component with certain display function, such as an LCD panel, an Organic light-emitting diode (OLED) panel, a TV, a monitor, a cell phone or smartphone, a computer, a notebook computer, a tablet, a digital photo-frame, or a navigation system, etc. As shown in FIG. 14, the display apparatus 400 includes a controller 402, a driver circuit 404, a memory 406, peripherals 408, and a display panel 410. Certain devices may be omitted and other devices may be included.

The controller 402 may include any appropriate processor or processors, such as a general-purpose microprocessor, digital signal processor, and/or graphic processor. Further, the controller 402 can include multiple cores for multi-thread or parallel processing. The memory 406 may include any appropriate memory modules, such as read-only memory (ROM), random access memory (RAM), flash memory modules, and erasable and rewritable memory, and other storage media such as CD-ROM, U-disk, and hard disk, etc. The memory 406 may store computer programs for implementing various processes, such as calculating the difference value of gray scale value of adjacent pixels; and restoring the actual gray scale value of the pixels, etc., when executed by the controller 402.

Peripherals 408 may include any interface devices for providing various signal interfaces, such as USB, HDMI, VGA, DVI, etc. Further, peripherals 408 may include any input and output (I/O) devices, such as keyboard, mouse, and/or remote controller devices. Peripherals 408 may also include any appropriate communication module for establishing connections through wired or wireless communication networks.

The driver circuitry 404 may include any appropriate driving circuits for driving the display panel 410. The display panel 410 may include any appropriate flat panel display, such as an LCD panel, an LED-LCD panel, a plasma panel, an OLED panel, etc. During operation, the display 410 may be provided with image signals by the controller 402 and the driver circuit 404 for display.

The display apparatus includes the disclosed substrate and the anti-reflective tandem structure included in the disclosed substrate may comprise a plurality of the light-absorbing layers. The light-absorbing layers may be able to absorb environmental lights. Thus, the reflection to the environmental light may be reduced. When the anti-reflective tandem structure is used to cover the substrate, the increasing of the brightness of pure black may be avoided. The contrast of the display apparatus is equal to the brightness of pure white divided by the brightness of pure black. Thus, reducing the reflection may increase the contrast of the display apparatus. Therefore, the image quality of the display apparatus may be enhanced.

The above detailed descriptions only illustrate certain exemplary embodiments of the present invention, and are not intended to limit the scope of the present invention. Those skilled in the art can understand the specification as whole and technical features in the various embodiments can be combined into other embodiments understandable to those persons of ordinary skill in the art. Any equivalent or modification thereof, without departing from the spirit and principle of the present invention, falls within the true scope of the present invention.

1-22. (canceled)

23. An anti-reflective tandem structure, comprising:
a plurality of light-absorbing layers,
wherein at least two of the plurality of light-absorbing layers have different concentrations of a non-metal element.

24. The anti-reflective tandem structure according to claim 23, wherein:
concentrations of the non-metal element in different layers of the plurality light-absorbing layers increase along the thickness direction.

25. The anti-reflective tandem structure according to claim 23, wherein:
concentrations of the non-metal element in different layers of the plurality light-emitting layers increase firstly, and then decrease along the thickness direction.

26. The anti-reflective tandem structure according to claim 25, wherein:
concentrations of the non-metal element in different layers of the plurality of the light-absorbing layer are symmetric with a light-absorbing layer with a highest non-metal concentration.

27. The anti-reflective tandem structure according to claim 23, wherein:
the concentration of the non-metal element in each of the plurality of light-absorbing layers is in a range of approximately 0˜15%.

28. The anti-reflective tandem structure according to claim 23, further including:
a transparent layer on at least one of a top surface and a bottom surface of the anti-reflective tandem structure.

29. The anti-reflective tandem structure according to claim 23, wherein:
the light-absorbing layers are made of one of metal oxide, metal nitride and metal oxynitride.

30. The anti-reflective tandem structure according to claim 23, wherein:
the metal oxide includes one or more of AlOₓ, CrOₓ, CuOₓ, MoOₓ, TiOₓ, AlNdOₓ, CuMoOₓ, MoTaOₓ, and MoTiOₓ, wherein “x” is an integer;
the metal nitride includes one or more of AlN_{y}, CrN_{y}, CuN_{y}, MoN_{y}, TiN_{y}, AlNdN_{y}, CuMoN_{y}, MoTaN_{y}, and MoTiN_{y}, wherein “y” is an integer; and
the metal oxynitride includes one or more of AlNₐO_{b}, CrNₐO_{b}, CuNₐO_{b}, MoNₐO_{b}, TiNₐO_{b}, AlNdNₐO_{b}, CuMoNₐO_{b}, MoTaNₐO_{b}, MoTiNₐO_{b}, wherein “a” and “b” are integers.

31. A substrate, comprising:
a base substrate; and
the anti-reflective tandem structure according to claim 23.

32. The substrate according to claim 31, wherein:
the substrate is a display substrate; and
the anti-reflective tandem structure is a black matrix on the display substrate.

33. The substrate according to claim 31, wherein:
the display substrate is a color filter on array (COA) substrate; and
the anti-reflective tandem structure is a black matrix disposed around the pixel electrodes.

34. The substrate according to claim 33, wherein:
the substrate is a touch substrate; and
the anti-reflective tandem structure is a bridging structure for connecting sensing electrodes on the substrate.

35. A display apparatus comprising a substrate according to claim 31.

36. A method for fabricating an anti-reflective tandem structure, comprising:
providing a base substrate; and
forming a plurality of light-absorbing layers on the base substrate,
wherein at least two of the plurality of light-absorbing layers have different concentration of non-metal elements.

37. The method according to claim 36, wherein:
concentrations of the non-metal element in different layers of the plurality light-absorbing layers increases from a first surface of the anti-reflective tandem structure to a second surface of the anti-reflective tandem structure.

38. The method according to claim 36, wherein:
concentrations of the non-metal element in different layers of the plurality light-emitting layers increase firstly, and then decrease, from a first surface of the anti-reflective to a second surface of the anti-reflective tandem structure.

39. The method according to claim 36, wherein:
each of the light-absorbing layers is formed by a sputtering process using a target comprising one of metal and metal alloy; and
an environmental gas of the sputtering process is one of a mixture of Ar and O₂, a mixture of Ar and N₂ and a mixture of Ar, N₂ and O₂.

40. The method according to any one of claim 36, after forming the plurality of light-absorbing layers, further including:
patterning the plurality of light-absorbing layers to form the anti-reflective tandem structure.

41. The method according to claim 39, wherein:
a temperature of the substrate during the sputtering process is in a range of approximately 25° C.˜150° C.;
a power of the sputtering process is in a range of approximately 5 kW˜15 kW;
a pressure of the sputtering process is in a range of approximately 0.1 Pa˜0.5 Pa;
a concentration of O₂ in the Ar and O₂ mixture is in a range of approximately 0˜20%;
a concentration of N₂ in the Ar and N₂ mixture is in a range of approximately 0˜20%; and
a total concentration of O₂ and N₂ in the Ar, N₂ and O₂ mixture is in a range of approximately 0˜20%.

42. The method according to claim 39, wherein:
the metal includes one of Al, Cr, Cu, Mo and Ti; and
the metal alloy includes one of AlNd, CuMo, MoTa and MoTi.
